(19) United States
(12) Patent Application Publication
(10) Pub. No.: US 2026/0051103 A1
(43) Pub. Date: Feb. 19, 2026

(54) METHOD AND SYSTEM FOR MANAGING AN AVATAR WITHIN A VIRTUAL ENVIRONMENT

(71) Applicant: SAMSUNG ELECTRONICS CO., LTD., Suwon-si (KR)

(72) Inventor: Rohan Rana, Noida (IN)

(73) Assignee: SAMSUNG ELECTRONICS CO., LTD., Suwon-si (KR)

(21) Appl. No.: 19/232,250

(22) Filed: Jun. 9, 2025

Related U.S. Application Data
(63) Continuation of application No. PCT/KR2025/006392, filed on May 12, 2025.

(30) Foreign Application Priority Data
Aug. 13, 2024 (IN) 202411061442

(51) Int. Cl. G06T 13/40

(52) U.S. Cl. CPC G06T 13/40; G06T 2213/12

(57) ABSTRACT

The present disclosure includes a method and a system for managing an avatar within a virtual environment. The method may include determining a position of the avatar in the virtual environment; identifying one or more virtual spaces in the virtual environment within a predetermined distance from the avatar based on the position of the avatar, determining one or more rules to be applied on the virtual environment, based on at least one of one or more avatar parameters and one or more virtual space parameters; and managing the avatar based on the one or more rules.

### CROSS REFERENCE TO RELATED APPLICATION

This application is a continuation of PCT/KR2025/006392, filed on May 12, 2025, at the Korean Intellectual Property Receiving Office and claims priority under 35 U.S.C. § 119 to Indian Patent Application number 202411061442 filed on Aug. 13, 2024, in the Indian Patent Office, the disclosure of which is incorporated by reference herein in its entirety.

### BACKGROUND

### 1. Field

The present disclosure relates to information processing and virtual space management systems, and more particularly, to management of an avatar in the virtual environment based on relative score, relative position, and conduct of avatar in one or more virtual spaces.

### 2. Description of Related Art

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

A virtual environment refers to a digital simulation of a real world having various virtual spaces, such as malls, clubs, gaming zones, restaurants, bar, etc. created by computer technology, where users can interact, engage, and experience immersive activities. This can include virtual reality (VR), augmented reality (AR), Metaverse, online gaming platforms, social media sites, and other digital spaces. The usage of virtual environments has been increasing exponentially, as they offer a wide range of benefits, such as enhanced collaboration, improved learning experiences, and endless entertainment opportunities. With the advancement of technology and the rise of remote work, virtual events, and social distancing measures, the adoption of virtual environments has accelerated, transforming the way we live, work, and play. As a result, virtual environments have become an integral part of modern life, with millions of users worldwide, and their increasing usage is expected to continue shaping the future of human interaction, entertainment, and innovation.

Further, in virtual environments where avatars represent users and interact within various virtual spaces, instances of misbehavior are of a significant concern due to the absence of an effective avatar management mechanism. Without oversight, avatars can engage in a range of inappropriate actions, including verbal harassment, bullying, and disruptive conduct, which can lead to a toxic atmosphere and negatively impact the experience of other users. The lack of a centralized authority to monitor and enforce behavioral norms means that avatars may exploit this gap by engaging in offensive or harmful activities with impunity. This absence of regulation and oversight extends to the misuse of inventory items as well. Further, the avatars might use or display items in ways that are inappropriate for the specific virtual space. For example, avatars might bring restricted or inappropriate items into spaces where their use is forbidden, which further may result in conflicts and reduce the overall quality of interaction in the virtual environments. Thus, such chaos and disorder highlight the urgent need for a structured regulatory mechanism capable of overseeing avatar conduct and managing inventory use to ensure a respectful and orderly virtual environment avatar.

Currently, there is no authority that monitors or enforces rules on avatars, resulting in the absence of regulatory mechanisms. This lack of oversight allows avatars to act at their own discretion, potentially leading to the infringement of other users' sentiments through verbal harassment, threats, misbehavior, unlawful touch, chaos, and other forms of inappropriate behavior. Consequently, there is a pressing need for a regulatory mechanism to manage and control the behavior of each avatar, preventing such disruptive activities. Additionally, there is no existing solution to check and analyze the usage of inventory items by avatars. Without a regulatory mechanism to oversee inventory usage, avatars might enter virtual spaces where certain items are prohibited or misuse items inappropriately. Therefore, there is an essential need to develop a regulatory mechanism that monitors inventory items and restricts their usage to ensure compliance with the rules of each virtual space and prevent misuse.

Hence, there exists a need to provide an enhanced solution for oversight of avatar behavior within a virtual environment by managing avatar behavior and inventory to ensure compliance with virtual space rules and to maintain a respectful and harmonious environment.

### SUMMARY

This section is provided to introduce certain aspects of the present disclosure in a simplified form that are further described below in the detailed description. This summary is not intended to identify the key features or the scope of the claimed subject matter.

According to an aspect of the present disclosure includes a method for managing an avatar within a virtual environment. The method may include determining a position of the avatar in the virtual environment; identifying one or more virtual spaces in the virtual environment within a predetermined distance from the avatar based on the position of the avatar; determining one or more rules to be applied on the virtual environment, based on at least one of one or more avatar parameters and one or more virtual space parameters; and managing the avatar based on the one or more rules. According to an aspect of the present disclosure, a system for managing an avatar within a virtual environment. The system includes memory and one or more processors operatively connected at least to the memory. The one or more processors are configured to, individually or collectively determine a position of the avatar in the virtual environment, identify one or more virtual spaces in the virtual environment within a predetermined distance from the avatar based on the position of the avatar, determine one or more rules, to be applied on the virtual environment, based on at least one of one or more avatar parameters and one or more virtual space parameters, and manage the avatar based on the one or more rules.

According to an aspect of the present disclosure, a non-transitory computer readable storage medium stores instructions for managing an avatar within a virtual environment is provided. The one or more instructions, when executed by one or more processors, cause the one or more processors to, individually or collectively, determine a position of the avatar in the virtual environment, identify one or more virtual spaces in the virtual environment within a predetermined distance from the avatar based on the position of the avatar, determine one or more rules, to be applied on the virtual environment, based on at least one of one or more avatar parameters and one or more virtual space parameters, and manage the avatar based on the one or more rules. Brief

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an example block diagram of a system for regulating the avatar within the virtual environment, in accordance with one or more embodiments of the disclosure;

FIG. 2 illustrates another example block diagram of a system for regulating the avatar within the virtual environment, in accordance with one or more embodiments of the disclosure;

FIG. 3 illustrates an example process for regulating an avatar within a virtual environment, in accordance with one or more embodiments of the disclosure;

FIG. 4 illustrates a flow diagram of a method for regulating an avatar within a virtual environment, in accordance with one or more embodiments of the disclosure;

FIG. 5 illustrates an example graphical representation of a Recurrent Neural Network (RNN) model for determining an avatar conduct score within a virtual environment, in accordance with one or more embodiments of the disclosure;

FIG. 6 illustrates an example graphical representation of a Neural Network (NN) based model for determining an optimal avatar score, in accordance with one or more embodiments of the disclosure; and

FIG. 7 illustrates an example graphical representation of a Neural Network (NN) model for classifying an inventory of an avatar, in accordance with one or more embodiments of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter may each be used independently of one another or with any combination of other features. An individual feature may not address any of the problems disclosed above or might address only some of the problems disclosed above.

The ensuing description provides example embodiments only, and is not intended to limit the scope, applicability, or configuration of the disclosure. Rather, the ensuing description of the example embodiments will provide those skilled in the art with an enabling description for implementing embodiments. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

It should be noted that the terms “first”, “second”, “primary”, “secondary”, “target” and the like, herein do not denote any order, ranking, quantity, or importance, but rather are used to distinguish one element from another.

Also, it is noted that individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional operations not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a Digital Signal Processing (DSP) core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from unit(s) which are required to implement the features of the present disclosure.

All modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

One or more of the plurality of modules may be implemented through an AI model. A function associated with AI may be performed through the non-volatile memory, the volatile memory, and the processor. The processor may include one or a plurality of processors. For implementing the one or the plurality of modules through an AI model, the one or the plurality of processors may be a general purpose processor(s), such as a central processing unit (CPU), an application processor (AP), or the like, a graphics-only processing unit such as a graphics processing unit (GPU), a visual processing unit (VPU), and/or an AI-dedicated processor such as an image processor. The one or the plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm(s) to a plurality of learning data, a predefined operating rule or AI model of a desired characteristic is made. The learning may be performed in a device itself in which AI according to an embodiment is performed, and/or may be implemented through a separate server/system. The AI model may consist of a plurality of neural network layers, such as long short-term memory (LSTM) layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

As used herein, a virtual environment may refer to a networked application that allows a user to interact with both the computing environment and the work of other users. The virtual environment may be created for example by combining various technologies such as Artificial Intelligence (AI), Augmented Reality (AR), Virtual Reality (VR), Mixed Reality (MR), etc. to allow people to access the virtual world. For instance, AR technologies can integrate virtual objects into the real world. Similarly, VR technology allows users to experience 3D virtual environments or 3D reconstructions using 3D computer modelling. The virtual environment may also refer to virtual worlds in which users represented by avatars interact, usually in 3D and is focused on social and economic connection.

As used herein, a virtual space may refer to a digitally created and bounded area within the virtual environment that may simulate real-world locations or imaginative locations within such virtual environments. The virtual spaces may be designed for specific purpose or specific activities which may also be differentiated based on their purpose, functionality, and interactive elements within such virtual spaces. It may be noted that the term “virtual spaces,” “one or more virtual spaces”, “virtual space” may have been used interchangeably, and shall be considered to mean the same, however, may indicate different quantity of the virtual space, and such terms shall be considered as a person skilled in art would be understand.

As used herein, an avatar may refer to a visual representation of the character which is controlled by the user. The avatar may be a 2D representation or a 3D-representation of the character. The avatar may be customizable and may be able to perform a variety of functions.

As used herein, coordinates may refer to a set of points which may indicate a location on a multi-dimensional plane. The coordinates may also refer to a set of numbers and/or letters that are used for finding the position of a point on a map, graph, computer screen, or the multi-dimensional plane, etc.

As disclosed in the background section above, the current known solutions have several shortcomings. An aspect of the present disclosure to provide a method and a system for regulating an avatar within a virtual environment. It is another aspect of the present disclosure to provide a solution to determine one or more rules to be applied on the virtual environment for regulating the avatar based on avatar parameters and virtual space parameters. It is another aspect of the present disclosure to provide a solution to regulate an avatar conduct to prevent harassment, bullying, and other forms of unacceptable conduct from the avatar within the virtual environment. It is another aspect of the present disclosure to provide a solution that determines a probability of the avatar breaking the one or more rules and performing one or more restrictive actions and one or more permissive actions to regulate the avatar conduct in the virtual environment.

The present disclosure overcomes the above-mentioned and other existing problems in this field of technology by providing a novel solution for managing an avatar within a virtual environment. Further, the solution of the present disclosure, provides mechanisms for overview the avatar within the virtual environment by tracking avatar IDs, positions, and behaviors. Then the disclosure generates conduct scores, including chaos and harassment scores, and inventory scores based on the items present in an inventory of the avatar. The present disclosure then retrieves and monitors relevant rules for each virtual space and adjusts access policies based on the tracked avatar IDs, positions, behavior, and the generated conduct scores. Further, the disclosure detects avatar presence, determines relative positions, identifies applicable rules for each virtual space, and thereafter manages access to activities and inventories by the avatar in each virtual space.

Further, embodiments of the present disclosure may also teleport the avatar to another virtual space from the current virtual space of the avatar in order to manage the avatar in the event of a rule-break by the avatar. Thus, the present disclosure ensures a safe and respectful virtual environment, promotes healthy user engagement, and prevents the misuse of inventory items. By leveraging embodiments of this disclosure, virtual spaces can maintain harmony and decorum, while avatars can interact and engage in a secure and controlled manner.

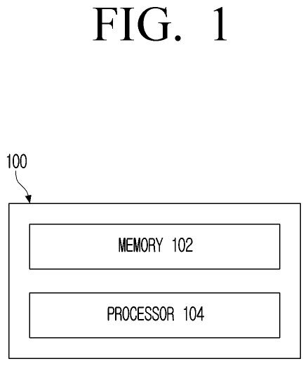

Referring to FIG. 1, an example block diagram of a system 100 for regulating an avatar within a virtual environment, in accordance with example embodiments of the present disclosure is shown. The system 100 comprises at least one processor 104, and at least one memory 102. Also, all of the components/units of the system 100 are assumed to be connected to each other unless otherwise indicated below. Also, in FIG. 1 only a few units are shown, however, the system 100 may comprise multiple such units, or the system 100 may comprise any such number of said units, as required to implement the features of the present disclosure. Further, in an embodiment, the system 100 may reside in and/or connected to and/or in communication with a user device (may also be referred herein as a user equipment or a UE) to implement the features of the present disclosure. In another embodiment, the system 100 may reside in a server.

At least one of the components, elements, modules and units (collectively “components” in this paragraph) represented by a block in the drawings such as FIG. 1 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

Further, in order to manage the avatar within the virtual environment, the processor 104 is configured to determine, a relative position of the avatar in the virtual environment. Further, in an embodiment, the relative position of the avatar is determined by the processor 104 based on a current position of the avatar in the virtual environment and a position of one or more entities in the virtual environment.

Further, the processor 104 is configured to identify, one or more virtual spaces within the virtual environment in a proximity of the avatar or within a predetermined distance from the avatar, wherein the avatar comprises an avatar ID, and an inventory. Further, in an embodiment, the avatar ID is used for detecting a presence of the avatar within the virtual environment and fetching, using the avatar ID, at least one of a metadata associated with the avatar, one or more first parameters and one or more second parameters from a database associated with the virtual environment.

Further, the processor 104 is configured to determine one or more rules, to be applied on the virtual environment, based on at least one of, one or more avatar parameters and one or more virtual space parameters. Further, the one or more avatar parameters comprise at least one of an avatar conduct score, an inventory score and an optimal avatar score. Further, in an embodiment, the one or more rules comprise at least one of a set of predefined rules, and a set of dynamic rules, and wherein the set of predefined rules are fetched from a database associated with the virtual environment, wherein the set of dynamic rules are determined based on one or more properties of the one or more virtual spaces, and wherein the one or more properties comprise at least one of a size, a layout, an environment, a purpose, one or more entities within the one or more virtual spaces, and an entity mapping.

Furthermore, in an embodiment, the processor 104 is configured to generate a probability vector associated with an avatar conduct based on a past conduct of the avatar and the one or more rules, wherein the probability vector indicates a probability of the avatar of breaking the one or more rules and wherein the probability vector is used to manage the avatar.

Furthermore, in another embodiment, the processor 104 is configured to determine an avatar score based on the avatar conduct score and the inventory score. Further, the avatar conduct score is determined by the processor 104 based on an analysis of one or more first parameters, and wherein the one or more first parameters comprise at least one of a behavior of the avatar within a current virtual space, a behavior of the avatar within one or more past virtual spaces, a body part movement, an eye gaze parameter, an interaction parameter, a speech parameter, the position of the avatar and the relative position of the avatar. The body part movement comprises at least one of a joint angle, a velocity, an acceleration, and a trajectory, associated with a motion of the avatar. The eye gaze parameter comprises at least one of one or more gaze target coordinates, and a direction. The interaction parameter comprises at least one of an interaction type, a duration, a number of interactions, and an interaction outcome. The position of the avatar comprises at least one of one or more coordinates associated with positioning of the avatar, and a vector of the one or more coordinates, and wherein the position of the avatar is within the virtual environment and the one or more virtual spaces. The speech parameter comprises at least one of a tone, a pitch, and a sensitivity of spoken words.

Further, in an embodiment, the processor 104 is configured to classify the avatar conduct score into one or more conduct categories based on the analysis of the one or more first parameters, the analysis of the one or more first parameters being based on a multi-label classifier technique of a Recurrent Neural Network (RNN) model.

Further, in another embodiment, the inventory score is determined by the processor 104 based on an analysis of one or more second parameters, and wherein the one or more second parameters comprise at least one of a name, a type, a quantity, and usage analytics associated with one or more items present within an inventory of the avatar. Further, the inventory score further comprises one or more item scores associated with the one or more items within the inventory of the avatar, and wherein the one or more item scores being determined based on the analysis of the one or more second parameters. Further, as used herein, the usage analytics refers to a data that depicts how the one or more items present within the inventory of the avatar are utilized, interacted with, or consumed, by the avatar.

Further, in an embodiment, the processor 104 is configured to classify the inventory of the avatar into one or more inventory categories based on the analysis of the one or more second parameters, and wherein the analysis of the one or more second parameters is based on a multi-label classifier technique of a Neural Network (NN) technique.

Further, the processor 104 is configured to regulate, the avatar based on the determined one or more rules. Further, in an embodiment, the processor 104 is configured to perform one or more actions to manage the avatar, wherein the one or more actions comprising one or more restrictive actions, and one or more permissive actions.

Furthermore, in an embodiment, the one or more permissive actions comprises at least one of allowing the avatar to enter a virtual space from the one or more virtual spaces and allowing the avatar to remain within the virtual space from the one or more virtual spaces.

Furthermore, in another embodiment, the one or more restrictive actions comprises at least one of restricting the access of the avatar, removing one or more items from an inventory of the avatar, restricting usage of the one or more items within the inventory of the avatar, restricting one or more capabilities of the avatar within the virtual space, and relocating the avatar from the virtual space. Further, the restricting the access of the avatar comprises performing at least one of a body parts restriction, a zone restriction, a sight restriction, a time restriction, an interaction restriction, a proximity restriction, an inventory restriction and an activity restriction, or a combination thereof.

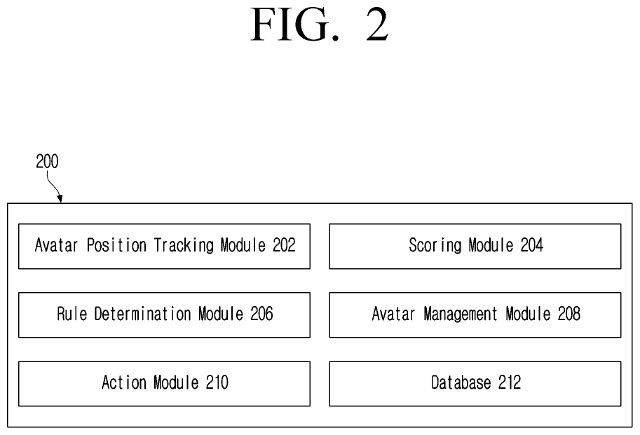

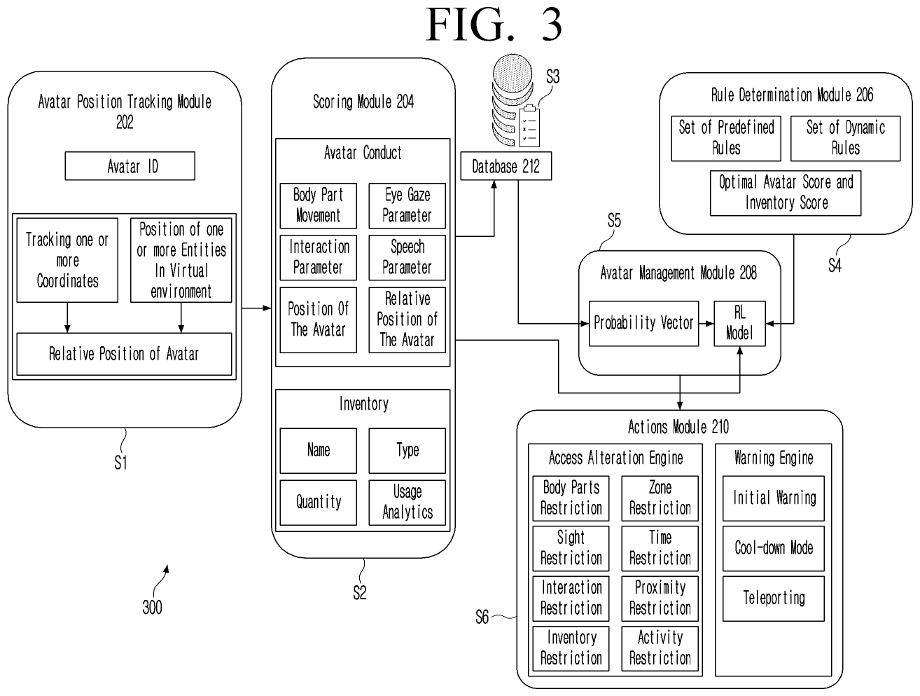

Referring to FIG. 2, another example block diagram of a system 200 for regulating the avatar within the virtual environment, in accordance with example embodiments of the present disclosure is shown. Further, the system 200, in an embodiment, comprises the example modules to implement one or more features of the present disclosure. These example modules as shown in FIG. 3, in an embodiment, may be implemented by the processor 104 of the system 100.

As shown in FIG. 2, the system 200 comprises an avatar position tracking module 202, a scoring module 204, a rule determination module 206, a avatar management module 208, an action module 210, and a database 212. Each of these modules may be explained in detail with reference to one or more figures in the forthcoming description. Further, for regulating the avatar in the virtual environment, other associated software components may also be used, wherein these other associated software components may be used in conjunction with the system 100 and the system 200.

Further, in accordance with the present disclosure, it is to be acknowledged that the functionality described for the various components/units can be implemented interchangeably. While specific embodiments may disclose a particular functionality of these units for clarity, it is recognized that various configurations and combinations thereof are within the scope of the disclosure. The functionality of specific units as disclosed in the disclosure should not be construed as limiting the scope of the present disclosure. Consequently, alternative arrangements and substitutions of units, provided they achieve the intended functionality described herein, are considered to be encompassed within the scope of the present disclosure.

The avatar position tracking module 202 may be used for continuously tracking the one or more coordinates associated with positioning of the avatar. The avatar position tracking module 202 may also be used for tracking a position of the avatar relative to the one or more entities or landmarks present in the virtual space and the virtual environment i.e., the relative position of the avatar. The avatar position tracking module 202 may also be used for determination of the relative position of the avatar based on the one or more coordinates of the avatar and a mapping of the one or more entities.

The scoring module 204 may be used for analysis of avatar conduct and the inventory of the avatar. The scoring module 204, after the analysis, generates scores for different conduct of the avatar and the inventory of the avatar. The analysis of the avatar conduct involves the scoring module 204 to analyze a body movement, an eye gaze, an interaction, the positioning of the avatar, a speech, and the relative position of the avatar. The inventory analysis of the avatar involves the scoring module 204 to analyze the one or more items within the inventory, usage analytics of the one or more items, the positioning of the avatar, and the relative position.

The rule determination module 206 may be configured to manage the avatar in the virtual environment by establishing and optimizing rules for the virtual environment. The rule determination module 206 is configured to evaluate and apply at least one of a predefined rules and system-generated rules to manage the avatar in the virtual environment. The predefined rules are the rules that may be set by administrators or users of the virtual environment and often reflect personal preferences, community standards, or any legal requirements. In contrast, the system-generated rules are created dynamically through real-time data analysis, considering factors and properties specific to the virtual environment. These rules may also be influenced by practices observed in similar virtual environments. Additionally, the rule determination module 206 may calculate an avatar optimal conduct and an inventory score to assesses the suitability of actions and for inventory management within the virtual environment.

The avatar management module 208 is configured to manage avatar access policies by aligning them with both avatar behavior and the rules governing the virtual environment. The avatar management module 208 may utilize a trained engine to continuously learns and refines the avatar access policies based on avatar actions. Further, the trained engine may be a reinforcement learning (RL) model that regulates the avatar access policies to promote authorized behavior while restricting authorized behavior by the avatar in the virtual environment. Additionally, the avatar management module 208 may be configured to calculate a probable avatar score based on recent interactions of the avatar within the virtual environment, to estimate an likelihood of future action/behavior of the avatar in the virtual environment.

The action module 210 is configured to perform actions on the avatar in accordance with the policies established by the trained model. Further, the action module 210 may further comprise an access alteration engine and the warning engine. The access alteration engine is configured to manage and/or modify one or more access aspects of the avatar such as body movement, speaking, listening, dancing, pushing, vision, and inventory. These modifications are guided by the policies learned by the trained model to ensure the avatar adheres to the rules of the virtual environment. Further, the warning engine of the action module 210 may be configured to issue alerts when a behavior of the avatar reaches near a threshold of acceptable limits, wherein the alerts may comprise sending an initial warning message, placing the avatar in cool-down mode, or teleporting the avatar from the virtual environment.

The database 212 is configured to store data associated with the avatar such as the avatar conduct score, the inventory score and any other such like data associated with the avatar.

Referring to FIG. 3, wherein the FIG. 3 illustrates an example process 300 for regulating an avatar within a virtual environment, in accordance with example embodiments of the present disclosure. In an embodiment, the process 300 is performed by the system 200. Further, in an embodiment, the process 300 is performed by the system 200 in conjunction with the system 100, wherein at least one of the system 100 and the system 200 may be present in a user equipment (UE) to implement the features of the present disclosure.

As shown in FIG. 3 at S1 an avatar position tracking module 202 continuously tracks the one or more coordinates associated with positioning of the avatar. The avatar position tracking module 202 is used for tracking a position of the avatar relative to the one or more entities or landmarks present in the virtual space and the virtual environment i.e., the relative position of the avatar. The avatar position tracking module 202 may be used to determine the relative position of the avatar based on the one or more coordinates of the avatar and a mapping of the one or more entities.

Further, at S2 a scoring module 204 is used for analysis of avatar conduct and an inventory of the avatar. The scoring module 204, after the analysis, generates scores for different conduct of the avatar and the inventory of the avatar. The analysis of the avatar conduct involves the scoring module 204 to analyze a body movement, an eye gaze, an interaction, the positioning of the avatar, a speech, and the relative position of the avatar. The inventory analysis of the avatar involves the scoring module 204 to analyze the one or more items within the inventory, usage analytics of a name, a type, a quantity, and usage analytics associated with one or more items present within an inventory of the avatar.

Further, at S3 an output of the analysis of avatar conduct and an inventory of the avatar is stored in the database 212 i.e., the avatar conduct score and the inventory score.

Further, at S4 a rule determination module 206 manages the avatar in the virtual environment by establishing and optimizing rules for the virtual environment. The rule determination module 206 evaluates and applies at least one of a predefined rules and system-generated rules i.e., set of dynamic rules, to manage the avatar in the virtual environment. The predefined rules are the rules that may be set by administrators or users of the virtual environment and often reflect personal preferences, community standards, or any legal requirements. In contrast, the system-generated rules are created dynamically through real-time data analysis, considering factors and properties specific to the virtual environment. These rules may also be influenced by practices observed in similar virtual environments. Additionally, the rule determination module 206 may calculate an avatar optimal conduct and an inventory score to assesses the suitability of actions and for inventory management within the virtual environment.

Further, at S5 an avatar management module 208 manages avatar access policies by aligning them with both avatar behavior and the rules governing the virtual environment. The avatar management module 208 may utilize a trained engine to continuously learn and refine the avatar access policies based on avatar actions. Further, the trained engine may be a reinforcement learning (RL) model that regulates the avatar access policies to promote authorized behavior while restricting unauthorized behavior by the avatar in the virtual environment. Additionally, the avatar management module 208 may be configured to calculate a probable avatar score based on recent interactions of the avatar within the virtual environment based on the analysis of avatar conduct and the inventory of the avatar, to estimate a likelihood of future action/behavior of the avatar in the virtual environment.

Further, at S6 an action module 210 performs actions on the avatar in accordance with the policies established by the trained model. Further, the action module 210 may further comprise an access alteration engine and a warning engine. The access alteration engine is configured to manage and/or modify one or more access aspects of the avatar such as body movement, speaking, listening, dancing, pushing, vision, and inventory. These modifications are guided by the policies learned by the trained model to ensure that the avatar adheres to the rules of the virtual environment. Further, the warning engine of the action module 210 may be configured to issue alerts when a behavior of the avatar reaches near a threshold of acceptable limits, wherein the alerts may comprise sending an initial warning message, placing the avatar in cool-down mode, or teleporting the avatar from the virtual environment.

It is to be noted that the operational designations S1, S2, S3, S4, S5, and S6, and similar labels, do not imply any particular order, ranking, quantity, or importance. These designations are used solely to distinguish different elements of the process 300. A person skilled in the art will appreciate that each of these elements may be performed in any order, simultaneously, or in a combination thereof, to implement the present disclosure.

Furthermore, it is noted that the operations S1, S2, S3, S4, S5, and S6, as described in the process 300, are exemplary in nature. They may comprise any number of additional operations or steps, which will be apparent to a person skilled in the art, to implement the present disclosure. Further, the process 300 is described in conjunction with method 400, wherein each operation of the process 300 is further elaborated upon in the corresponding operations of method 400. Specifically, the various aspects of process 300 are detailed in method 400 to provide a comprehensive understanding of the overall process.

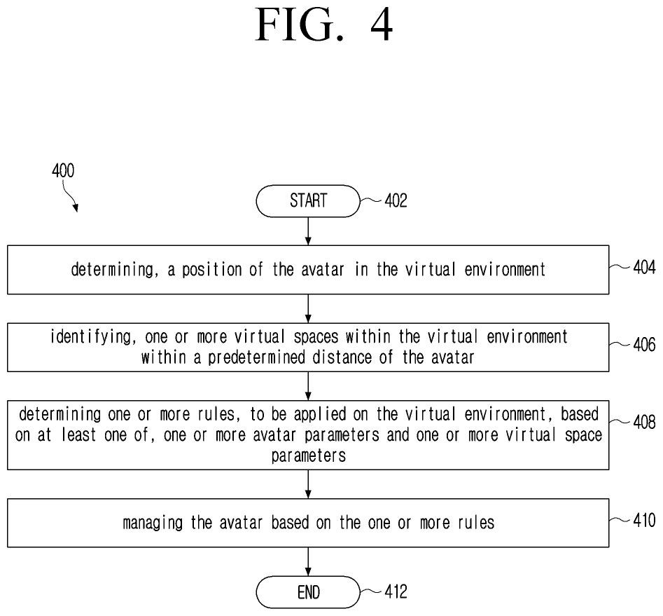

Referring to FIG. 4, wherein the FIG. 4 illustrates a flow diagram of a method 400 for regulating an avatar within a virtual environment, in accordance with example embodiments of the present disclosure. In an embodiment the method 400 is performed by a system 100. Further, in another embodiment the method 400 is performed by a system 200. Further, in an embodiment, the method 400 is performed by the system 100 in conjunction with the system 200, wherein at least one of the system 100 and the system 200 may be present in a user equipment (UE) to implement the features of the present disclosure. The method 400 as depicted in FIG. 4 starts at operation 402.

Next, at operation 404, the method 400 comprises determining, a relative position of the avatar in the virtual environment. Further, the relative position of the avatar is determined based on a current position of the avatar in the virtual environment and a position of one or more entities in the virtual environment. Further, the avatar may comprise at least one of an avatar ID and an inventory.

As used herein, “the relative position of the avatar” may refer to a location of the avatar within the virtual environment in relation to the one or more entities and/or reference points present within the virtual environment, such as a landmark. The relative position of the avatar signifies a spatial relationship between the avatar and its surroundings within the virtual environment, taking into account the distances, angles, and orientations between them.

Further, as used herein, the “current position of the avatar” may refer to an absolute location of the avatar within the virtual environment at a specific point in time. The current position of the avatar represents precise coordinates, orientation, and state of the avatar within the virtual environment. Further, the current position of the avatar may be determined based on an initial position of the avatar, a velocity of the avatar, an acceleration of the avatar, and any other such like parameters that may be appreciated by a person skilled in the art in order to determine the current position of the avatar.

Further, as used herein, the “position of the one or more entities” may refer to locations of objects, characters, and/or points of interest that are present within the virtual environment.

Further, the inventory associated with the avatar may refer to a collection of virtual items, objects, and resources that may be owned, possessed, and/or utilised by the avatar within the virtual environment. The inventory may include digital goods such as weapons, clothing, accessories, tools, one or more currencies of the virtual environment and any other such like assets.

Further, in an embodiment of the present disclosure, the avatar ID may be used for detecting a presence of the avatar within the virtual environment. Furthermore, the avatar ID may be used for fetching at least one of a metadata associated with the avatar, one or more first parameters and one or more second parameters from a database associated with the virtual environment.

Further, as used herein “the metadata associated with the avatar” may comprise an information that signifies attributes of a particular avatar such as a name, an age, and an appearance, a behavioral data like movement patterns and an interaction history of the particular avatar. Additionally, the metadata associated with the avatar may also comprise a data related to a location of the particular avatar, a data related to a user-defined settings associated with the particular avatar, a data related to a progress and achievements of the particular avatar, and any other such like data that may be appreciated by a person skilled in the art as necessary to implement the present disclosure.

Next, at operation 406, the method 400 comprises identifying, one or more virtual spaces within the virtual environment in a proximity of the avatar or within a predetermined distance of the avatar. Further, the one or more virtual spaces within the virtual environment in the proximity of the avatar or within a predetermined distance of the avatar may be identified based on one or more predefined virtual space identification rules. Further, in an example embodiment of the present disclosure, a predefined virtual space identification rule to identify one or more virtual spaces in a particular virtual environment may fetch a mapping data structure associated with said particular virtual environment from a database associated with said particular virtual environment. Further, the fetched mapping data structure may comprise a set of information associated with dimensions of the one or more virtual spaces present within said particular virtual environment, coordinates of placement of the one or more entities within the one or more virtual spaces, landmarks of the one or more virtual spaces and any other points of interest that may be present in the one or more virtual spaces. Furthermore, the predefined virtual space identification rule may also receive real-time updates of changes in the one or more virtual spaces and may store an updated mapping data structure of the one or more virtual spaces in the database associated with said particular virtual environment. It is to be noted that the predefined virtual space identification rule as discussed above is exemplary in nature and should not be interpreted in a manner to restrict the scope of the disclosure. Further, the one or more predefined virtual space identification rules may comprise any such rule that may be appreciated by a person skilled in the art to implement the present disclosure.

Further, as used herein, the “one or more virtual spaces” may refer to areas or regions within the virtual environment that are designated for specific purposes, such as interaction zones, activity areas, navigation paths and any other such like areas/regions. Further, the one or more virtual spaces may be a static space and/or a dynamic space. The dynamic space may refer to a virtual space that changes one or more parameters such as a shape, a size, and/or a location in response to an activity performed by the avatar in the virtual space such as movements or actions.

Further, in an example embodiment of the present disclosure, an avatar position tracking module 202 may be utilised to determine current position of the avatar in the virtual environment. For ease of understanding, let us consider an example, wherein an avatar such as avatar A, is the avatar ID of the avatar. Further, the avatar A is present in a virtual environment Z, wherein the virtual environment Z may comprise a virtual space 1, a virtual space 2, and a virtual space 3. Further, the avatar position tracking module 202 may determine the virtual space 2 as the current position of the avatar A in the virtual environment Z. Further, in an example embodiment of the present disclosure, one or more position determination technique to determine the current position of the avatar A in the virtual environment Z. For instance, a position determination technique in order to determine the current position of the avatar A, may comprise determining coordinates of the avatar A with respect to coordinates of an entry point associated with the virtual space 2 in order to detect an entry of the avatar A in the virtual space 2. Further, once the entry of the avatar A in the virtual space 2 is detected, the position determination technique in order to determine the current position of the avatar A, may comprise fetching a set of moment data associated with the avatar A within the virtual space 2, wherein the set of moment data may be received via a hardware unit, such as a controller. Further, the set of moment data may comprise a velocity of the avatar A, an acceleration of the avatar A, an orientation of the avatar A and other such like moment parameters. Thereafter the fetched moment data may be utilised to determine the coordinates associated with the current position of the avatar A. Furthermore, the coordinates associated with the current position of the avatar A may be determined based on the following equation (hereinafter also referred as equation 1):

$$x = {x}_{0} + {v}_{xo} \cdot t + 1 / 2 \cdot {a}_{x} \cdot {t}^{2} ,$$

$$y = {y}_{0} + {v}_{yo} \cdot t + 1 / 2 \cdot {a}_{y} \cdot {t}^{2} , and$$

$$z = {z}_{0} + {v}_{zo} \cdot t + 1 / 2 \cdot {a}_{z} \cdot {t}^{2} .$$

wherein,
x represents a current position coordinate of the avatar A within the virtual space 2 along in reference to x-axis of the virtual space 2,
y represents a current position coordinate of the avatar A within the virtual space 2 along in reference to y-axis of the virtual space 2,
z represents a current position coordinate of the avatar A within the virtual space 2 along in reference to z-axis of the virtual space 2,
xₒ represents an initial position coordinate of the avatar A within the virtual space 2 along in reference to the x-axis of the virtual space 2,
yₒ represents an initial position coordinate of the avatar A within the virtual space 2 along in reference to the y-axis of the virtual space 2,
yₒ represents an initial position coordinate of the avatar A within the virtual space 2 along in reference to the z-axis of the virtual space 2,
vₓₒ, v_{yo}, and v_{zo} represents an initial velocity of the avatar A within the virtual space 2 along the x-axis, the y-axis and the z-axis respectively, and
aₓ, a_{y}, and a_{z} represents an acceleration of the avatar A within the virtual space 2 along the x-axis, the y-axis and the z-axis respectively.

Furthermore, continuing from the above example, the virtual space 2 may comprise one or more entities such as an entity C1, an entity C2, an entity C3, an entity C4 and an entity C5. Next, at least one of a position and a dimension of each of the entity C1, the entity C2, the entity C3, the entity C4 and the entity C5 in the virtual space 2 may be fetched from the database. For, instance the fetched position and the fetched dimensions of each said one or more entities in the virtual space 2 are as follows:

TABLE 1

| Entity | Position (x, y, z) | Dimension |
|---|---|---|
| C1 | 221, 45, 6 | 222 × 134 × 10 |
| C2 | 113, 88, 2 | 120 × 49 × 5 |
| C3 | 333, 100, 0 | 333 × 200 × 34 |
| C4 | 0, 0, 0 | 100 × 100 × 2 |
| C5 | 13, 56, 2 | 200 × 150 × 40 |

Thereafter, the solution of the present disclosure, may determine the relative position of the avatar A in the virtual space 2 based on the determined the current position of the avatar A in the virtual space 2 by utilising the equation 1 and the determined position of one or more entities (i.e., the entity C1, the entity C2, the entity C3, the entity C4 and the entity C5) in the virtual space 2 (as depicted in table 1 above). Furthermore, the determined relative position of the avatar A in the virtual space 2 may comprise at least a direction, a distance, an orientation, and a projection of the avatar A in reference to the one or more entities in the virtual space 2.

As used herein, “the direction” of a particular avatar may refer to a vector that indicates a direction of movement of the particular avatar within a virtual environment and/or a virtual space, such as a forward direction. Further, the direction of the particular avatar may be represented by a 3-Dimensional (3D) vector or a set of angles (e.g., pitch, yaw, roll) that describe an orientation of said particular avatar within the virtual environment and/or the one or more virtual spaces.

Further, as used herein, “the distance” of the particular avatar may refer to the measure of how far the particular avatar is from a specific point, object, the one or more entities and/or location within the virtual environment and/or the one or more virtual space. Furthermore, the distance may be represented by at least one of a scalar value (e.g., meters, units) and a vector that describes the displacement between the particular avatar and the one or more entities of the virtual environment and/or the one or more virtual spaces.

Further, as used herein, “the orientation” of the particular avatar may refer to an alignment of the particular avatar within the virtual environment and/or the one or more virtual spaces to depict a state of position of the particular avatar relative to the virtual environment and/or the one or more virtual spaces such as moving ahead, moving back, entering, exit and any other such like state of position.

Further, as used herein, “the projection of the avatar” may refer to a representation of a 3D position, the orientation, and shape of the particular avatar onto a 2-Dimensional (2D) surface such as a screen or display.

Next, at operation 408, the method 400 comprises determining one or more rules, to be applied on the virtual environment, based on at least one of, one or more avatar parameters and one or more virtual space parameters. Further, as disclosed by the present disclosure, the one or more avatar parameters may comprise at least one of an avatar conduct score, an inventory score and an optimal avatar score.

Further, in an embodiment of the present disclosure, the one or more rules may comprise at least one of a set of predefined rules, and a set of dynamic rules, and wherein the set of predefined rules are fetched from a database associated with the virtual environment. Further, the set of dynamic rules may be determined based on one or more properties of the one or more virtual spaces of the virtual environment, wherein the one or more properties comprise at least one of a size, a layout, an environment, a purpose, one or more entities within the one or more virtual spaces, and an entity mapping. Furthermore, in an embodiment of the present disclosure, the one or more virtual space parameters may be based on the one or more properties of the one or more virtual spaces.

Further, the size of the one or more virtual spaces may refer to dimensions of said virtual space, defining the area associated with the one or more virtual spaces in which the avatar may perform one or more actions, such as moving, interacting, and exploring. The dimensions of the one or more virtual spaces may be measured in terms of length, width, height, and/or volume, wherein the one or more virtual spaces may be at least one of a fixed virtual space and a dynamically changing virtual space. The dynamically changing virtual space refers to a virtual space wherein one or more of the dimensions of the one or more virtual spaces change in response to one or more actions performed by at least one of one or more avatars within the virtual space, an administrator of the virtual space and any other such like entities.

Further, in an embodiment, a predefined rule associated with the one or more virtual spaces to be applied on the virtual environment, may comprise a set of instruction to manage the one or more avatar parameters within the one or more virtual spaces, wherein the set of instructions may be based on the one or more virtual space parameters. For instance, if an avatar B enters a virtual space X, then a predefined rule P1 associated with the one or more virtual spaces may comprise a set of instructions to be followed by the avatar B in the virtual space X, such as do not waste food, do not wear sandals, do not make fraudulent entry, maintain 1 meter distance from one or more avatars and any other such like instructions to manage the one or more avatar parameters.

Further, the layout of the one or more virtual spaces may refer to an arrangement and organization of the one or more entities in the one or more virtual spaces, such as paths, obstacles, tables, chairs, landmarks and any other such like entities.

Further, the environment of the one or more virtual spaces may refer to an ambiance, an atmosphere, and sensory characteristics of the one or more virtual spaces. The environment of the one or more virtual spaces may be based on at least one of a visual, auditory, tactile, and other sensory elements, such as lighting, textures, sounds, and effects of the one or more virtual spaces.

Further, the purpose of the one or more virtual spaces refers to a function, a goal, and an objective of the one or more virtual spaces within the virtual environment. The purpose of the one or more virtual spaces may signify specific activities, such as training, education, and entertainment that may be attributed to the one or more virtual spaces within the virtual environment.

Further, the one or more entities within the one or more virtual spaces refer to objects, landmarks, characters, weapons, any other such like entity that are part of the one or more virtual spaces. Further, the entity mapping refers to relationships, connections, and/or associations between the one or more entities within the one or more virtual spaces such as entrance, exit, tables, chairs, light, path. The entity mapping may include spatial relationships, social connections, and functional dependencies among the one or more entities within the one or more virtual spaces that enable the one or more entities to interact, collaborate, and influence each other.

Further, in an example embodiment of the present disclosure, the avatar conduct score is determined based on an analysis of one or more first parameters. Furthermore, the one or more first parameters may comprise at least one of a behavior of the avatar within a current virtual space, a behavior of the avatar within one or more past virtual spaces, a body part movement, an eye gaze parameter, an interaction parameter, a speech parameter, the position of the avatar and the relative position of the avatar.

As used herein, the “avatar conduct score” may refer to a measure of a parameter that represents a behavior and actions of an avatar within the virtual environment. The avatar conduct score may be determined based on an analysis of a real-time behavior and actions of the avatar in a particular virtual space and a past behavior and actions of the avatar in said particular virtual space.

Further, in an embodiment of the present disclosure, the body part movement may comprise at least one of a joint angle, a velocity, an acceleration, and a trajectory, associated with a motion of the avatar. Further, the joint angle may refer to a degree of flexion, extension, and/or rotation of one or more joints of the avatar, such as elbows, knees, and/or shoulders, that indicates a posture, and a movement of a body part associated with the avatar.

Further, the velocity may refer to a speed and direction of the movement of the body part, such as an arm, a leg, a head, and alike body parts. The acceleration refers to a rate of change of the velocity and may indicate a measure of rapidness associated with a change in the speed and direction of the movement of the body part. Further, the trajectory may refer to a path and/or a probable curve that may be inflicted by the avatar based on the movement of the body part, such as the hand, foot, or torso, i.e., a pattern of movement.

Further, in an example embodiment of the present solution, the body part movement of the avatar may be indicated by a body part movement vector generated based on at least one of the joint angle, the velocity, the acceleration, and the trajectory, associated with the motion of the avatar. Furthermore, each of the joint angle, the velocity, the acceleration, and the trajectory, associated with the motion of the avatar may be represented by corresponding numerical values that may be utilised to generate the body part movement vector.

Further, in another embodiment of the present disclosure the eye gaze parameter may comprise at least one of one or more gaze target coordinates and a direction. Further, the one or more gaze target coordinates may indicate spatial locations in the one or more virtual spaces at which the eyes of the avatar is focused such as a temple. The direction may refer to an orientation or vector based on the one or more gaze target coordinates that represents the direction in which eyes of the avatar eyes are currently pointing such as a north direction of the temple.

Furthermore, the eye gaze parameter may also encompass a gaze behavior, wherein the gaze behavior may be based on one or more gaze parameters such as a gaze duration that represents a measure of time for which the avatar focuses on a particular target, a gaze shift that represents a frequency of movement of the eyes of the avatar from one target to another, and any other such like gaze parameter that may be appreciated by a person skilled in the art to implement the present solution.

Further, in an example embodiment of the present solution, the eye gaze parameter of the avatar may be indicated by an eye gaze vector generated based on one or more of the eye gaze parameter. Furthermore, each of the eye gaze parameter may be represented by corresponding numerical values that may be utilized to generate the eye gaze vector.

Further, in an embodiment of the present disclosure the interaction parameter may comprise at least one of an interaction type, a duration, a number of interactions, and an interaction outcome. Further, as used herein, the “interaction parameter” may refer to a measure of an engagement by the avatar with the one or more entities within the one or more virtual spaces to represent a nature, an extent, and an outcome of said engagement by the avatar. Further, interaction type may represent a category and/or a classification of the interaction, such as clicking, hovering, grasping, speaking, gesturing, that signifies a manner of the engagement by the avatar. Furthermore, the duration refers to a length of time associated with the engagement by the avatar with one or more entities within the one or more virtual spaces. Further, the number of interactions may refer to a frequency and/or a count of the engagement by the avatar with the one or more entities within the one or more virtual spaces. Further, the interaction outcome represents a result and/or consequence of the engagement by the avatar with the one or more entities within the one or more virtual spaces, such as positive, negative, failure, success, reward, penalty, and any other such like result and/or consequence.

Further, in an example embodiment of the present solution, the interaction parameter of the avatar may be indicated by an interaction vector generated based on one or more of the interaction type, the duration, the number of interactions, and the interaction outcome. Furthermore, each of the interaction type, the duration, the number of interactions, and the interaction outcome may be represented by corresponding numerical values that may utilised to generate the interaction vector.

Further, in an embodiment of the present disclosure, the position of the avatar may comprise at least one of one or more coordinates associated with positioning of the avatar, and a vector of the one or more coordinates, wherein the position of the avatar is within the virtual environment and the one or more virtual spaces. Further, as used herein, the “position of the avatar” may refer to a precise location and orientation of the avatar within the virtual environment and/or the one or more virtual spaces. Further, the one or more coordinates refers to a specific x, y, z coordinates or spatial locations that represents the precise location and orientation of the avatar within the virtual environment and/or the one or more virtual spaces of the virtual environment. Further, the vector of the one or more coordinates refers to a numerical representation of the precise location and orientation of the avatar, wherein the numerical representation is generated based on a distance of the precise location from a reference point such as the landmarks and direction of the precise location from said reference point.

Further, in an embodiment of the present disclosure the speech parameter may comprise at least one of a tone, a pitch, a sensitivity of spoken words. Further, as used herein, the speech parameter may refer to a measure of the spoken words by the avatar that represents an auditory characteristics and emotional content of a speech by the avatar. Further, the tone may refer to an attitude that is conveyed by the spoken words of the avatar, such as neutral, flirty, calm, friendly, serious, sarcastic, enthusiastic and any other such like attitude. Further, the pitch may refer to a value of intensity of the tone associated with the spoken words. Further, the sensitivity of spoken words may represent a category associated with the spoken words such as abusive words, emotional words, technical words, and any other such like category.

Further, in an example embodiment of the present solution, the speech parameter of the avatar may be indicated by a speech vector generated based on at least one of the tone, the pitch, and the sensitivity of spoken words. Furthermore, each of the tone, the pitch, and the sensitivity of spoken words may be represented by corresponding numerical values that may be utilised to generate the speech vector. It is to be noted that the speech parameter as disclosed above is exemplary in nature and may comprise any other such like parameters that may be appreciated by a person skilled in the art to determine the speech vector.

Further, in an example embodiment the solution of the present disclosure as disclosed herein may further comprise classifying, the avatar conduct score into one or more conduct categories based on the analysis of the one or more first parameters, the analysis of the one or more first parameters being based on a multi-label classifier technique of a Recurrent Neural Network (RNN) model.

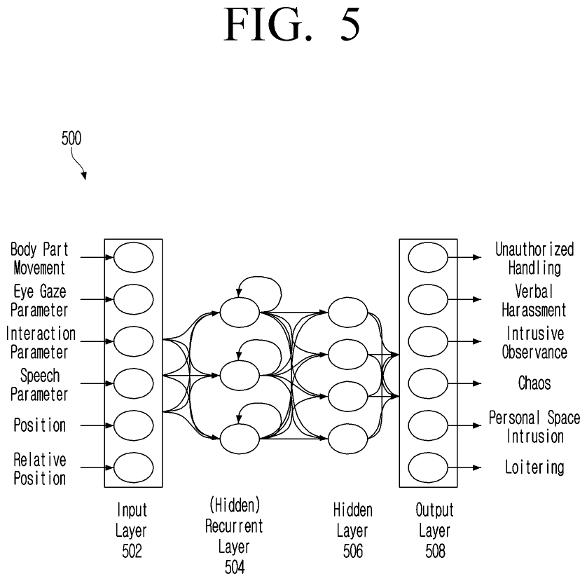

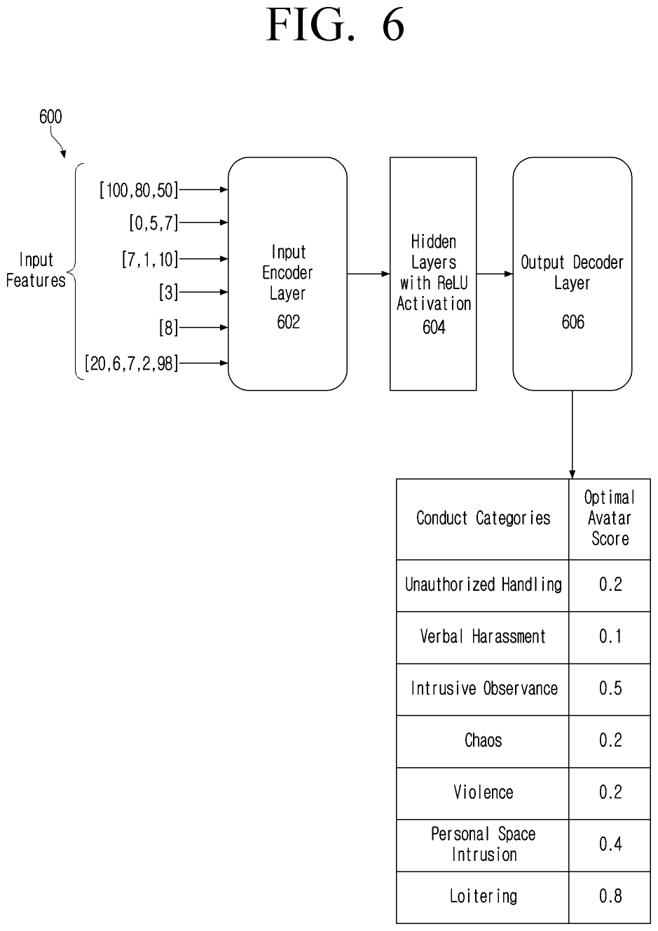

Now referring to FIG. 5, wherein FIG. 5 illustrates an example graphical representation of a Recurrent Neural Network (RNN) model 500 for determining an avatar conduct score within a virtual environment, in accordance with one or more embodiments of the disclosure; Further, the example RNN model 500 may comprise at least an input layer 502, a recurrent layer 504, a hidden layer 506 and an output layer 508. Further, in an embodiment, the avatar conduct score within the virtual environment may be determined by utilizing one or more conduct determination rules. Furthermore, in an example embodiment, the example RNN model 500 to determine an avatar conduct score of an avatar may comprise receiving at the input layer 502 a sequence of input features such as, the body part movement, the eye gaze parameter, the interaction parameter, the speech parameter, the position of the avatar and the relative position of the avatar. Further, the recurrent layer 504 of the example RNN model 500 may retain past data related to a conduct of the avatar and may utilize the past data to generate at the hidden layer 506 at least the body part movement vector, the eye gaze vector, the interaction vector, and the speech vector that represent the conduct of the avatar in the one or more virtual space. Further, in an embodiment, the hidden layer 506 may utilize a Rectified Linear Unit (ReLU) activation function to generate each of the body part movement vector, the eye gaze vector, the interaction vector, and the speech vector by introducing non-linearity, which limits the value of each vector between 0 and 1.Further, the output layer 508 of the example RNN model 500 may categorize the determined avatar conduct score in the one or more conduct categories such as an unauthorized handling, a verbal harassment, a distrustful surveillance, a chaos, a violence, a personal space intrusion, a violence, a loitering, and any other such like categories. Further, the example RNN model 500 may categorize the determined avatar conduct score in the one or more conduct categories by comparing the determined avatar conduct score and an optimal avatar score. It is to be noted that the optimal avatar score generation is explained in detail with reference to FIG. 6.

Further, in an embodiment of the present disclosure, the optimal avatar score may be determined by utilizing one or more neural network determination techniques. Furthermore, in an example embodiment of the present disclosure, a neural network determination techniques may determine the optimal avatar score based on the one or more properties of the one or more virtual spaces, the position of the one or more entities in the virtual environment and the interaction parameter.

Referring to FIG. 6, which illustrates an example graphical representation of a Neural Network (NN) based model 600 for determining an optimal avatar score, in accordance with one or more embodiments of the disclosure; The Neural Network (NN) based model 600 comprises at least an input encoder layer 602, one or more hidden layers 604, and an output decoder layer 606. The NN based model 600 determines the optimal avatar score based on the properties of the virtual spaces, the position of entities in the virtual environment, and the interaction parameter (depicted as input features in FIG. 6). For ease of understanding, let us consider that the input features received at the input encoder layer 602 have corresponding values as depicted in FIG. 6. The hidden layers 604 utilizes a Rectified Linear Unit (ReLU) activation function to generate a value associated with each input feature, ranging between 0 and 1. Thereafter, the output decoder layer 606 determines the optimal avatar score associated with the virtual environment based on the input features. Additionally, the output decoder layer 606 categorizes the conduct of the avatar into conduct categories based on the determined optimal avatar score (as shown in FIG. 6).

In an example embodiment of the present disclosure, the determined avatar conduct score is categorized as an unauthorized handling in an event an inappropriate interaction with at least one of objects and/or other avatars from the avatar is detected, such as using an object in a way by the avatar that is not permitted or using an object in a context by the avatar that is not suitable such as throwing chairs on the other avatars.

In an example embodiment of the present disclosure, the determined avatar conduct score is categorized as a verbal harassment in an event the spoken words by the avatar to the other avatars are one of abusive, offensive, and/or unwelcome words such as insults, threats, abusive language, and any other such like words.

In an example embodiment of the present disclosure, the determined avatar conduct score is categorized as a distrustful surveillance in an event of a deliberate and an inappropriate watching of sensitive or personal scenes in the one or more virtual spaces without permission, such as staring at another avatar with high intensity and frequency.

In an example embodiment of the present disclosure, the determined avatar conduct score is categorized as a chaos in an event a behavior of the avatar is such that it disrupts an order and/or a harmony of the one or more virtual spaces, such as property damage, making loud noises, erratic movements, and/or loud random speech.

In an example embodiment of the present disclosure, the determined avatar conduct score is categorized as a personal space intrusion in an event the avatar invades a personal space of the other avatars without permission of corresponding avatars, such as getting too close to another avatar.

In an example embodiment of the present disclosure, the determined the avatar conduct score is categorized as loitering in an event the avatar is lingering in a location with the one or more virtual spaces without a specific purpose.

In an example embodiment of the present disclosure, the determined avatar conduct score is categorized as violent in an event the avatar exhibits an aggressive and/or a harmful action towards at least one of the other avatars and the one or more entities, such as fighting, attacking, or any other forms of aggressive behavior.

Further, in accordance with the present disclosure, the inventory score is determined based on an analysis of one or more second parameters, and wherein the one or more second parameters comprise at least one of a name, a type, a quantity, and usage analytics associated with one or more items present within the inventory of the avatar. Furthermore, in said embodiment the inventory score may further comprise one or more item scores associated with the one or more items within the inventory of the avatar, and wherein the one or more item scores being determined based on the analysis of the one or more second parameters.

As used herein, the “inventory score” refers to a value that represents a composition and frequency of utilization of one or more items present in the inventory of the avatar. Further, the name may refer to an identifier of each item one or more items present in the inventory of the avatar such as gun A, and gun B, western dress, and ethnic dress. Further, the type represents a classification of said each item e.g., weapon for the gun A and the gun B, clothing for the western dress and the ethnic dress and any other such like classifications. Further, the quantity may represent a number of said each item present in the inventory of the avatar such as 1 gun A and 1 gun b, 1 western dress and 3 ethnic dress (ethnic A, ethnic B, and ethnic C). Further, the usage analytics may refer to a data that depicts the frequency of use of each item by the avatar such as gun A is used frequently, ethnic dress B is used less frequently, and the western dress is used occasionally.

Further, the solution of the present disclosure may further comprise classifying, the inventory of the avatar into one or more inventory categories based on the analysis of the one or more second parameters. Further, the analysis of the one or more second parameters may be based on at least a multi-label classifier technique of a Neural Network (NN). Further, in an example embodiment, a NN model in order to classify, the inventory of the avatar into the one or more inventory categories.

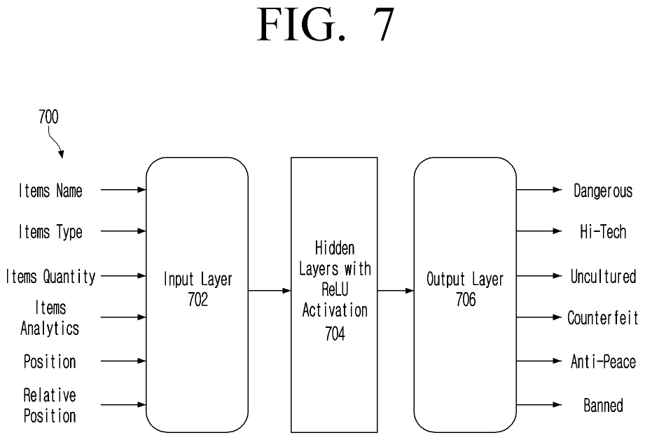

Now referring to FIG. 7 wherein FIG. 7 illustrates an example graphical representation of an example Neural Network (NN) model 700 for classifying an inventory of an avatar, in accordance with example, one or more embodiments of the disclosure; Further, the example NN model 700 may comprise at least an input layer 702, one or more hidden layers 704, and an output layer 706. Further, in the example NN model 700 may comprise determining by the output layer 706 the inventory score based on one or more item scores, wherein the one or more inventory categories may be a dangerous, a hi-tech, a uncultured, a controversial, a counterfeit, a banned, an anti-peace, and any other such like category. The one or item scores may be calculated by the hidden layer 704 based on the analysis of the second parameters received at the input layer 702. Further, the hidden layer 704 may utilize a Rectified Linear Unit (ReLU) activation function to analyze patterns and relationships between one or more items of the inventory and the avatar. Further, the hidden layers 704 limits the one or more item scores of the one or more items of the inventory between 0 and 1 introducing non-linearity based on an predefined rule such as f(x)=max(0, x). Furthermore, the output layer 706 may utilize a sigmoid activation function to predict the probability of the one or item belonging to the one or more inventory categories, wherein the sigmoid activation function encompasses multiple output nodes, each representing a different category from the one or more inventory categories for classifying the inventory of the avatar. Further, item scores reflect a value, a utility, a performance, and a usage pattern of each item from the one or more items present in the inventory of the avatar. Further, the inventory score may be represented by range of numerical values such as between 0 to 1 where 0 means highly absent and 1 means highly present.

Further, in an example embodiment of the present disclosure, the inventory of the avatar is classified as dangerous in a scenario the one or more items are such that pose a physical or virtual threat, such as explosives, weapons, or hazardous materials, which can cause harm to the avatar or others in the virtual environment.

Further, in an example embodiment of the present disclosure, the inventory of the avatar is classified as hi-tech in a scenario the one or more items are such that utilize an advanced technology, such as robotics, gadgets and innovative tools that demonstrate a high level of technological expertise.

Further, in an example embodiment of the present disclosure, the inventory of the avatar is classified as counterfeit in a scenario the one or more items are fake or unauthorized replicas of the one or more items, which can deceive or mislead the other avatars.

Further, in an example embodiment of the present disclosure, the inventory of the avatar is classified as controversial in an event the one or more items are likely to cause controversy/disagreement among users of the virtual environment due to their nature, such as political symbols, sensitive religious artifacts, a provocative content that may spark a debate and/or a conflict.

Further, in an example embodiment of the present disclosure, the inventory of the avatar is classified as banned in an event the one or more items are restricted items within the one or more virtual spaces due to their nature, such as illegal drugs, weapons, an explicit content, and any other such like items.

Further, in an example embodiment of the present disclosure, the inventory of the avatar is classified as uncultured in an event the one or more items are considered culturally insensitive to certain groups of the users, such as offensive symbols, stereotypes, an insensitive content, and any other such like items.

Further, in an example embodiment of the present disclosure, the inventory of the avatar is classified as anti-peace in an event the one or more items are such that promote violence, unrest, and/or conflict within the one or more virtual spaces, such as weapons, a propaganda material, a hate speech, and any other such like items.

Further, continuing from the example discussed above, a metadata, one or more first parameters and one or more second parameters associated with the avatar A may be fetched from the database associated with the virtual environment Z. Further, the one or more first parameters may provide an information related to a real time conduct of the avatar A and a conduct of the avatar A within virtual environment Z, such as behavior of the avatar A in real time within the virtual space 2, a past behavior of the avatar A within the virtual space 2. Furthermore, the one or more second parameters may provide an information related to one or more items present within an inventory of the avatar A.

Further, it would be appreciated by a person skilled in the art that the above stated parameters, i.e., the one or more first parameters and the one or more second parameters are exemplary in nature and should not be interpreted in a manner to limit the scope of the present disclosure. Further, the one or more first parameters and the one or more second parameters may comprise any other such like parameters that may be appreciated by a person skilled in the art to implement the present disclosure.

Further, in an embodiment, the present disclosure may further comprise determining an avatar score based on the avatar conduct score.

In an embodiment of the present disclosure, the avatar score may be determined by utilising one or more score determination rules. Further, in an example embodiment, a score determination rule to determine the avatar score may comprise fetching at least one of the determined avatar conduct score, an entry time stamp associated with the one or more virtual spaces and an exit time stamp associated with the one or more virtual spaces. Next, the score determination rule may determine a virtual space score associated with the one or more virtual spaces, wherein the one or more virtual spaces score may be determined based on the comparison of the one or more virtual spaces and an updated one or more virtual spaces. Thereafter, the score determination rule to determine the avatar score may utilize the one or more virtual space score and at least one of the determined avatar conduct score, the entry time stamp and the exit time stamp associated with the one or more virtual spaces.

Next, at operation 410, the method 400 comprises regulating, the avatar based on the determined one or more rules. Further, the solution of the present disclosure may comprise generating, a probability vector associated with an avatar conduct based on a past conduct of the avatar and the one or more rules, Further, the probability vector indicates a probability of the avatar breaking the one or more rules, wherein the probability vector is used to manage the avatar.

Further, the probability vector associated with an avatar conduct may be determined by utilising one or more probability vector determination rules. Further, in an example embodiment, a probability vector determination rule to determine the probability vector may comprise fetching at least one of the determined avatar conduct score, the entry time stamp associated with the one or more virtual spaces and the exit time stamp associated with the one or more virtual spaces. Next, the probability vector determination rule may determine a weighted virtual space score associated with the one or more virtual spaces, wherein the weighted virtual space score may be determined based on a comparison of the mapping data structure of the one or more virtual spaces and a mapping data structure of the updated one or more virtual spaces. Further, the mapping data structure of the updated one or more virtual spaces is generated based on a timestamp of the one or more first parameters. Furthermore, the probability vector determination rule may fetch a past conduct score of the avatar in the one or more virtual spaces, wherein the past conduct score of the avatar is a score determined based on the past conduct of the avatar in one or more virtual spaces. Thereafter, the probability vector determination rule may utilize the weighted virtual space score and the past conduct of the avatar to determine the probability vector.

In an embodiment of the present disclosure, a reinforcement learning (RL) model may be utilized to manage the avatar within the virtual environment. Further, the RL model may be an artificial intelligence (AI) based model that is configured to manage avatar access policies to promote authorized behavior while restricting unauthorized behavior by the avatar in the virtual environment. The RL model for regulating the avatar, may analyze the one or more avatar parameters (i.e., the avatar conduct score, inventory score, and optimal avatar score), the current position of the avatar in the virtual environment, the probability vector, the position of one or more entities in the virtual environment, and the determined one or more rules. Further, based on said analysis and a learned policy, the RL model may perform one or more actions to manage the avatar, wherein the learned policy may comprise selecting a next best action based on mapping the optimal avatar score with one or more actions, wherein the one or more actions may include restrictive and permissive actions. Furthermore, the RL model may also receive feedback comprising a reward parameter from the virtual environment, wherein the reward indicates how well the one or more actions align with the determined one or more rules. Further, the learned policy may also be updated based on the reward.

Further, in an example embodiment of the present disclosure, the reward may be calculated based on the following equation:

$${R}_{t} = α \cdot {compliance}_{t} - β \cdot {violation}_{t} + γ \cdot {optimal}_{t} - δ \cdot {suboptimal}_{t}$$

wherein:
compliance, is a binary variable that indicates whether the avatar conduct score and inventory score are in compliance with the determined one or more rules at a particular time,
violationₜ is a binary variable that indicates whether the avatar conduct score and inventory score violates with the determined one or more rules at the particular time,
optimalₜ is a binary variable that indicates whether the avatar conduct score and inventory score are in compliance with the optimal avatar score at the particular time,
suboptimalₜ is a binary variable that indicates whether the avatar conduct score and inventory score are deviating the optimal avatar score at the particular time, and
α, β, γ, δ are weighting factors representing an importance of complianceₜ, violationₜ, optimalₜ and suboptimalₜ respectively in the reward.

Further, each weighting facto from the weighting factors may have a predefined value and/or a dynamically adjusted value, wherein the predefined value and the dynamically adjusted value may be based on the virtual environment.

Further, the solution of the present disclosure as disclosed herein may perform one or more actions to manage the avatar, wherein the one or more actions may be at least one of one or more restrictive actions, and one or more permissive actions.

Further, in an embodiment of the present disclosure, to perform the one or more permissive actions the solution of the present disclosure may further comprise allowing the avatar to enter a virtual space from the one or more virtual spaces. Furthermore, to perform the one or more permissive actions the solution of the present disclosure may further comprise allowing the avatar to remain within the virtual space from the one or more virtual spaces.

Further, in another embodiment of the present disclosure, to perform the one or more restrictive actions the solution of the present disclosure may further comprise restricting an access of the avatar. Furthermore, in another embodiment of the present disclosure, to perform the one or more restrictive actions the solution of the present disclosure may further comprise removing one or more items from an inventory of the avatar. Further, in order to perform the one or more restrictive actions, the solution of the present disclosure may comprise restricting usage of the one or more items present within the inventory of the avatar. Further, to perform the one or more restrictive actions the solution of the present disclosure may further comprise restricting one or more capabilities of the avatar within the one or more virtual spaces. Thereafter, to perform the one or more restrictive actions the solution of the present disclosure may further comprise relocating the avatar from the one or more virtual spaces.

Further, the restricting the access of the avatar may comprise performing at least one of a body parts restriction, a zone restriction, a sight restriction, a time restriction, an interaction restriction, a proximity restriction, an inventory restriction and an activity restriction.

Further, in an embodiment the body parts restriction for restricting the access of the avatar may refer to limiting a use of specific body parts of the avatar such as arms or legs, to restrict certain actions for a predefined time period that may be performed by the avatar.

Further, in an embodiment the zone restriction for restricting the access of the avatar may refer to restricting access to the one or more virtual spaces and/or one or more zones within the one or more virtual spaces such as private rooms, restricted territories.

Further, in an embodiment the sight restriction for restricting the access of the avatar may refer to limiting a visual perception of the avatar, such as blurring or blocking certain visuals, to prevent the avatar from viewing one or more information/events.

Further, in an embodiment the time restriction for restricting the access of the avatar may refer to limiting access to certain virtual space, the one or more entities based on time constraints, such as visiting home at night past 10 PM.

Further, in an embodiment the interaction restriction for restricting the access of the avatar may refer to limiting an ability of the avatar to interact with other avatars, the one or more entities.

Further, in an embodiment the proximity restriction for restricting the access of the avatar may refer to limiting an ability of the avatar to approach and/or be near at least one of the one or more entities, one or more avatars, the one or more virtual spaces and the one or more zones of the virtual spaces, or restricting the ability of the avatar to move more than a predetermined distance.

Further, in an embodiment the inventory restriction for restricting the access of the avatar may refer to limiting an ability of the avatar to possess, use, or access certain items from the one or more items present within an inventory of the avatar. For example, in a virtual environment such as a club, an avatar named “Player1” has an inventory that includes a costume, a sword, a shield, and a gun. Then, the solution of the present disclosure analyses an inventory of the Player1 and detects the presence of banned items, i.e., the sword and the gun, which are prohibited in the virtual environment. Thereafter, the solution restricts or disables access to the banned items, preventing the avatar from possessing, using, or accessing them. Further, with the restricted items disabled, Player1 can continue to explore the virtual environment, ensuring that the determined rules are adhered to within the virtual environment.

Further, in an embodiment the activity restriction for restricting the access of the avatar may refer to limiting an ability of the avatar to engage in certain activities, behaviors, or actions, such as restricting them from performing specific function/task such singing, speaking and any other such like functions/tasks.

In another example, in a scenario of a virtual meeting in a virtual conference room, let's suppose that an avatar X becomes engaged in a loud conversation with another avatar Y, disrupting the virtual meeting. The solution of the present disclosure, upon detecting the loud conversation and determining one or more rules of the virtual environment (i.e., the virtual conference room), may manage avatar X by temporarily lowering its voice volume to a whisper level, thereby restricting one or more capabilities of avatar X to speak loudly. Additionally, the warning engine of the action module 210 may be configured to issue alerts, stating, “Your voice volume is too loud; it has been temporarily lowered to avoid disrupting the meeting.”

Thereafter, the method 400 terminates at operation 412.

Yet another aspect of the present disclosure may relate to a non-transitory computer readable storage medium storing instructions for regulating an avatar within a virtual environment, the instructions include executable code which, when executed by a one or more units of a system 100, causes a processor 104 of the system 100 to determine, a relative position of the avatar in the virtual environment. Further. the executable code when executed causes the processor 104 of the system 100 to identify, one or more virtual spaces within the virtual environment in a proximity of the avatar. Further. the executable code when executed causes the processor 104 of the system 100 to determine one or more rules, to be applied on the virtual environment, based on at least one of, one or more avatar parameters and one or more virtual space parameters. Thereafter, the executable code when executed causes the processor 104 of the system 100 to regulate, the avatar based on the determined one or more rules.

As is evident from the above, the present disclosure provides a technically advanced solution for regulating an avatar within a virtual environment. The present disclosure provides a technically advanced solution that regulates and manages a behavior of the avatar for maintaining decorum and harmony in the virtual environment. The present disclosure discloses advanced regulatory mechanisms that prevent unauthorized activities, manage inventory items, and limit access to virtual spaces for maintaining decorum and harmony in the virtual environment. Further, the technically advanced solution of the present disclosure may leverage artificial intelligence and machine learning techniques to generate accurate predictions of unauthorized behavior and automate decision-making. Thus, the technically advanced solution of the present disclosure eliminates the need for manual intervention for regulating the avatar within the virtual environment, which in turn results in increased scalability, efficiency, and reduced costs in managing the avatar's behavior and maintaining decorum and harmony in the virtual environment. Also, the technical effect of the present disclosure lies in the provision of a robust and effective regulatory mechanism for avatars in virtual environments, promoting healthy user engagement and preventing misuse of inventory items. By monitoring avatar behavior and applying regulations, the disclosure ensures a safe and respectful virtual space. The technical effect of the present disclosure lies in its capability to be applied across multiple virtual spaces by considering past conduct of the avatar in one virtual space to enable more accurate and reliable predictions of the authorized behavior in another virtual space.

While considerable emphasis has been placed herein on the disclosed embodiments, it will be appreciated that many embodiments can be made and that many changes can be made to the embodiments without departing from the principles of the present disclosure. These and other changes in the embodiments of the present disclosure will be apparent to those skilled in the art, whereby it is to be understood that the foregoing descriptive matter to be implemented is illustrative and non-limiting.

What is claimed is:

1. A method for managing an avatar within a virtual environment, the method comprising:
determining a position of the avatar in the virtual environment;
identifying one or more virtual spaces in the virtual environment within a predetermined distance from the avatar based on the position of the avatar;
determining one or more rules to be applied on the virtual environment, based on at least one of one or more avatar parameters and one or more virtual space parameters; and
managing the avatar based on the one or more rules.

2. The method of claim 1, wherein the determining the position of the avatar in the virtual environment comprises determining the position of the avatar based on a current position of the avatar in the virtual environment relative to a position of one or more entities in the virtual environment.

3. The method of claim 1, wherein the one or more avatar parameters comprise at least one of an avatar conduct score, an inventory score, and an optimal avatar score.

4. The method of claim 1, the method further comprising:
generating a probability vector associated with an avatar conduct based on a past conduct of the avatar and the one or more rules, wherein the probability vector indicates a probability of the avatar of breaking the one or more rules, and
wherein managing the avatar is based on the probability vector.

5. The method of claim 3, wherein the avatar conduct score is based on one or more first parameters, and
wherein the one or more first parameters comprise at least one of: a behavior of the avatar within a current virtual space, a behavior of the avatar within one or more past virtual spaces, a body part movement of the avatar, an eye gaze parameter, an interaction parameter, a speech parameter, the position of the avatar relative to the position of one or more entities in the virtual environment, and the current position of the avatar in the virtual environment.

6. The method of claim 3, wherein the inventory score is based on one or more second parameters,
wherein the one or more second parameters comprise at least one of: a name, a type, a quantity, and usage analytics associated with one or more items present within an inventory of the avatar,
wherein the inventory score comprises one or more item scores associated with the one or more items within the inventory of the avatar, and
wherein the one or more item scores are based on the one or more second parameters.

7. The method of claim 1, wherein the avatar comprises an avatar ID and an inventory,
wherein the method further comprises:
detecting a presence of the avatar within the virtual environment based on the avatar ID; and
fetching, based on the avatar ID, at least one of a metadata associated with the avatar, one or more first parameters, and one or more second parameters from a database associated with the virtual environment.

8. The method of claim 1, further comprising:
determining a set of dynamic rules based on the one or more rules,
wherein the dynamic rules are determined based on one or more properties of the virtual space comprising at least one of a size of the one or more virtual spaces, a layout of the one or more virtual spaces, an environment of the one or more virtual spaces, a purpose of the one or more virtual spaces, one or more entities within the virtual space, and an entity mapping.

9. The method of claim 1, further comprising:
performing, one or more actions to manage the avatar, wherein the one or more actions comprise one or more restrictive actions, and one or more permissive actions.

10. The method of claim 9, wherein the one or more restrictive actions comprise at least one of:
restricting access of the avatar;
removing one or more items from an inventory of the avatar;
restricting usage of the one or more items within the inventory of the avatar;
restricting one or more capabilities of the avatar within the virtual space; and
relocating the avatar from the virtual space.

11. The method of claim 10, wherein the restricting the access of the avatar comprises performing at least one of a body part restriction, a zone restriction, a sight restriction, a time restriction, an interaction restriction, a proximity restriction, an inventory restriction, and an activity restriction.

12. A system for managing an avatar within a virtual environment, the system comprising:
memory, and
one or more processors operatively connected at least to the memory,
wherein the one or more processors are configured to, individually or collectively:
determine a position of the avatar in the virtual environment,
identify one or more virtual spaces in the virtual environment within a predetermined distance from the avatar based on the position of the avatar,
determine one or more rules, to be applied on the virtual environment, based on at least one of one or more avatar parameters and one or more virtual space parameters, and
manage the avatar based on the one or more rules.

13. The system of claim 12, wherein the determining the position of the avatar in the virtual environment comprises determining the position of the avatar based on a current position of the avatar in the virtual environment relative to a position of one or more entities in the virtual environment.

14. The system of claim 12, wherein the one or more avatar parameters comprise at least one of an avatar conduct score, an inventory score, and an optimal avatar score.

15. The system of claim 12, wherein the one or more processors are further configured to, individually or collectively:
generate a probability vector associated with an avatar conduct based on a past conduct of the avatar and the one or more rules, wherein the probability vector indicates a probability of the avatar of breaking the one or more rules, and
wherein managing the avatar is based on the probability vector.

16. The system of claim 14, wherein the avatar comprises an avatar ID and an inventory, and
wherein the one or more processors are further configured to, individually or collectively:
detect a presence of the avatar within the virtual environment based on the avatar ID; and
fetch at least one of a metadata associated with the avatar, one or more first parameters, and one or more second parameters from a database associated with the virtual environment, based on the avatar ID.

17. A non-transitory computer-readable medium storing one or more instructions, the one or more instructions, when executed by one or more processors, cause the one or more processors to, individually or collectively:
determine a position of the avatar in the virtual environment,
identify one or more virtual spaces in the virtual environment within a predetermined distance from the avatar based on the position of the avatar,
determine one or more rules, to be applied on the virtual environment, based on at least one of one or more avatar parameters and one or more virtual space parameters, and
manage the avatar based on the one or more rules.

18. The non-transitory computer-readable medium of claim 17, wherein the determining the position of the avatar in the virtual environment comprises determining the position of the avatar based on a current position of the avatar in the virtual environment relative to a position of one or more entities in the virtual environment.

19. The non-transitory computer-readable medium of claim 17, wherein the one or more avatar parameters comprise at least one of an avatar conduct score, an inventory score, and an optimal avatar score.

20. The non-transitory computer-readable medium of claim 17, wherein the one or more instructions, when executed by one or more processors, further cause the one or more processors to, individually or collectively:
generate a probability vector associated with an avatar conduct based on a past conduct of the avatar and the one or more rules,
wherein the probability vector indicates a probability of the avatar of breaking the one or more rules, and
wherein managing the avatar is based on the probability vector.
